(19) United States
(12) Patent Application Publication
(10) Pub. No.: US 2011/0291504 A1
(43) Pub. Date: Dec. 1, 2011

(54) Rim Motor/Generator (RMG)

(76) Inventor: Michael Niedzialkowski, Chicago, IL (US)

(21) Appl. No.: 12/761,249

(22) Filed: May 28, 2010

(51) Int. Cl. H02K 7/116

(52) U.S. Cl. 310/83

(57) ABSTRACT

The invention provides a Rim Electric Motor/Generator (RMG), utilizing the Solenoid principle which greatly increases the efficiency of an electric motor. The ring-shaped design allows the magnetic coils to wrap 360° around the rotor (FIG. 4), providing maximum possible ratio of transforming electric power to mechanical motion. Another benefit of the invention is low installation space requirements allowing it to be easily adapted in current designs (FIG. 7), without the need for major alterations. The scope of the invention includes the use of solenoid principle in said rim (ring) shape configuration of solenoids to generate circular motion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Electric motors we use today exist largely in the same form as when first introduced nearly 200 years ago. Over the years, several new types of motor/generators have been developed in an effort to improve efficiency. As hybrid, electric, and fuel-cell vehicles have gained more attention recently due to high oil prices, the need has risen to create a smaller and more powerful electric motor/generator. The invention I present under this patent application improves current electric motor design and changes the interaction between the rotor and the stator by adopting the solenoid principle. The new design is made from a number of solenoids enclosed in a rim (ring) shaped Stator (FIG. 3), which allows for a much more economical and efficient conversion of electricity into mechanical power, and vice versa. This solution also allows for generating maximum torque at low RPM, offering a major advantage over current electric engine designs.

### BRIEF SUMMARY OF THE INVENTION

The invention utilizes a specifically built round/tube shaped stator (FIG. 1) which allows the rotor to move within, propelled by magnetized coils generating maximum torque at any RPM setting. By adopting Rim Motor/Generator (RMG), car construction (to use the most obvious application) can be reconfigured, and transmission along with the gas engine replaced by a rechargeable battery set. The essence of the invention is that the motor is concentric with the wheel axis, with a simplified internal gear set installed to provide drive torque to the wheel. The wheel being part of the electric motor itself, offers a lot of room for placement of typical hardware, without compromising ride or handling. The invention won't take away any free space from the wheel assembly and will offer flexibility for the suspension geometry.

Charging options may vary from a simple AC outlet charge to more sophisticated solutions, ie: hydrogen fuel cells or hydrogen turbine utilizing the very same RMG as on-board Power Generator. The solenoid principle, as applied in the invention, makes regenerative breaking easy to implement, helping increase efficiency further by reducing the time required to charge batteries in an electric vehicle. Lastly, the invention can be used in any application used for energy generation; hydro, steam or wind generators.

### BRIEF DESCRIPTION OF THE DRAWINGS

FIG. 1 Stator/Rotor assembly
a. Stator made of non-magnetic material, specially designed to form a ring tube.
b. Rotor made of strong magnets and non-magnetic parts with specific design to match number of coils on the stator and internal gear on inside or gear rack on the outside part of its body.

FIG. 2 Stator/Rotor, internal gear, spur gear assembly.

FIG. 3 Stator/Rotor, internal gear, solenoid coils assembly.
Coils will be wrapped around the stator's tube in desired number and configuration.

FIG. 4 Stator/Rotor, internal gear, spur gear, solenoid coils assembly.

FIG. 5 Stator/Rotor, internal gear, spur gear, solenoid coils assembly (more detailed).

FIG. 6 Stator/Rotor, outside gear (gear rack) on rotor, spur gear, internal gear, solenoid coil assembly.

FIG. 7 Rim Motor/Generator (RMG) as an example of an in-wheel electric motor application. The desired number of spur gears will support the rotor from inside, outside, or both sides and transmit its movement directly to the receiver (vehicle's wheel). Size of the gears may be calculated to said conditions and desired RPM.

### DETAILED DESCRIPTION OF THE INVENTION

In current generation electric motor assembly, the motor requires high rotations-per-minute (RPM) to achieve necessary energy level, and then is slowed down by a gearbox or transmission to required torque and RPM output. Lots of energy is lost in the process just to move the gearbox or transmission, not to mention the additional weight, which sacrifices efficiency even further. Additionally, factors such as cost of operation, tear and wear, as well as environmental pollution, are all impacted by the current technology. Requiring many moving parts, these motors are also prone to breakdowns, hence requiring time-consuming and expensive maintenance work.

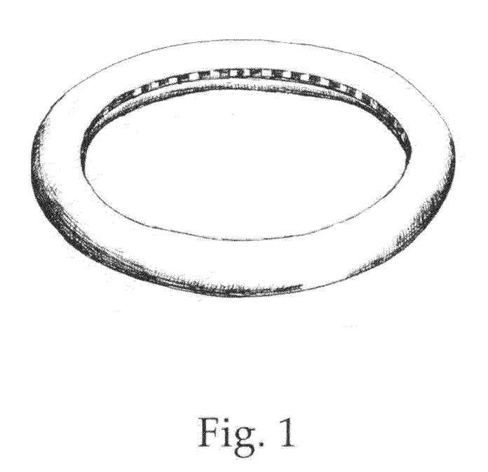

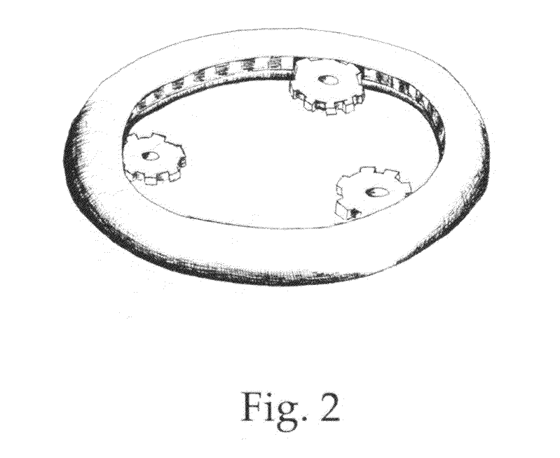

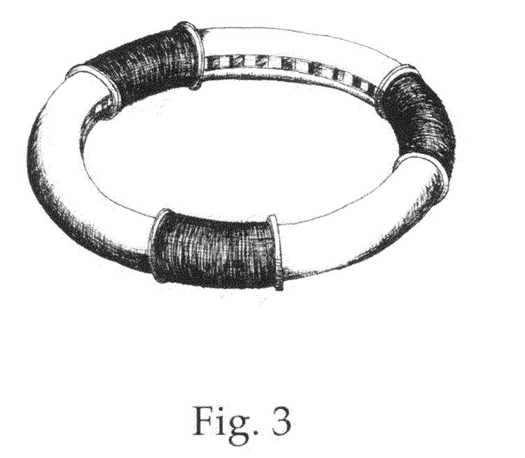

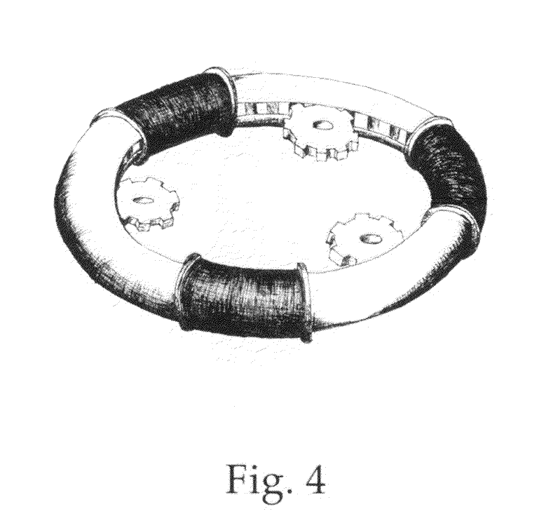

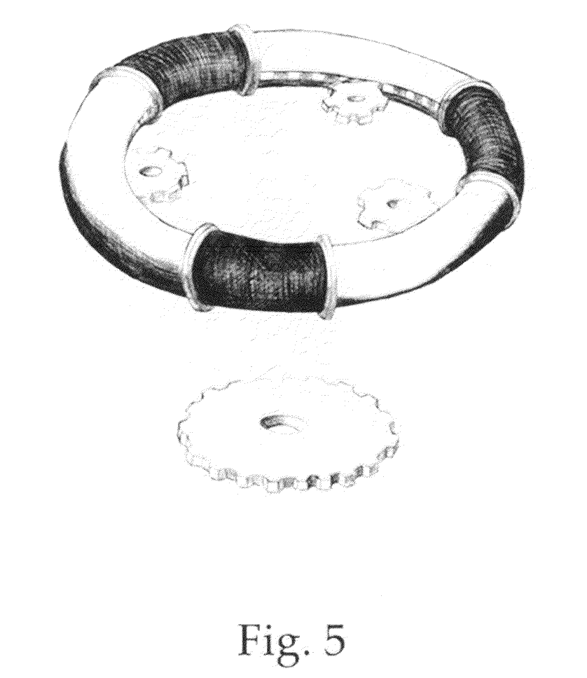

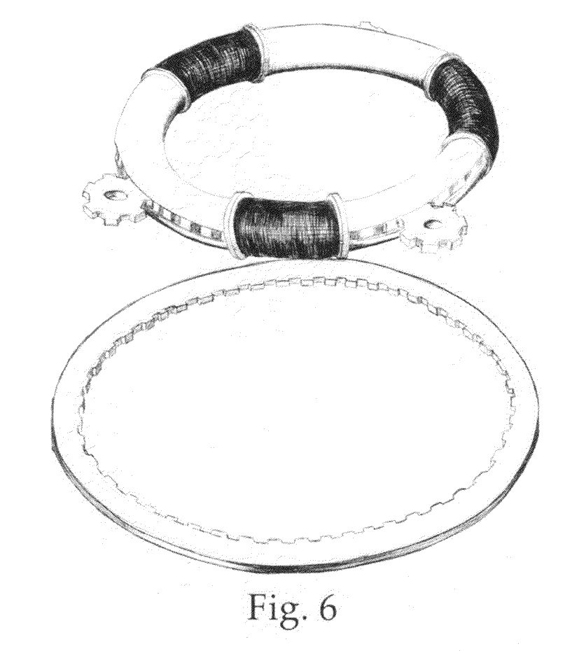

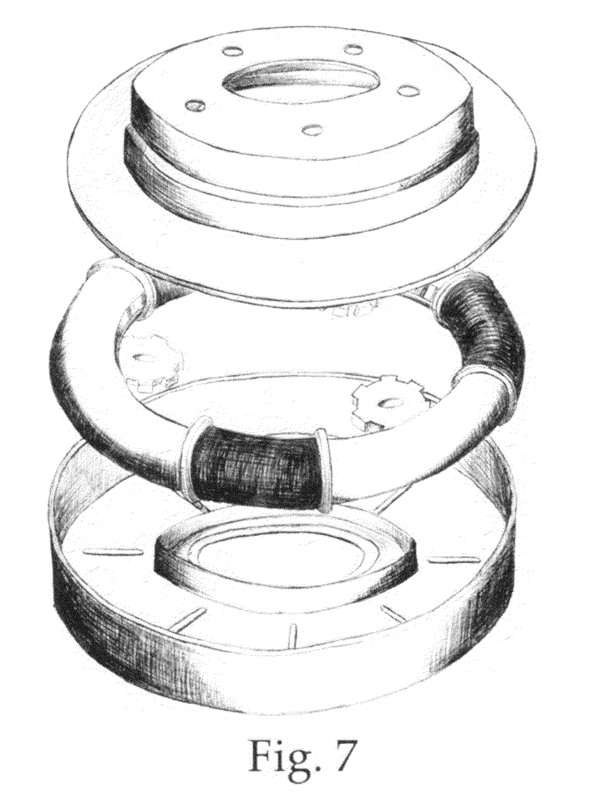

The invention utilizes the Solenoid principle to form low RPM—high torque output and converts electrical energy (and vice versa) into mechanical motion. By design, Solenoid converts electrical energy into linear or partial rotary motion. In my invention, series of solenoids (FIG. 3) are enclosed in a rim (ring) shaped Stator with (FIG. 2) the Core/Rotor spinning freely inside, supported from outside (FIG. 4) with no central axle as seen in standard electric motors, making it suitable for applications like in-wheel motor (FIG. 7), power generators, etc. It delivers rotary movement directly to the point where it is needed.

When an electrical current is passed through the coil windings, it behaves like an electromagnet and the Core/Rotor is attracted towards the centre of the coil by the magnetic flux setup within the coil's body, which rotates the Core/Rotor in required direction. The torque and speed of the Rotor movement is determined by the strength of the magnetic flux generated within the coil. The strength of this magnetic field can be increased or decreased by either controlling the amount of current flowing through the coil or by changing the number of turns or loops that the coil has. When the supply current is turned “OFF” (de-energized) the electromagnetic field generated previously by the coil collapses and sets the Rotor back to its rest (stop) position.

1. Rim Motor/Generator (RMG) assembly comprising: a ring-shaped stator made of a tube with a series of solenoids wrapped around it; a magnetic rotor located inside said stator and free to spin with the support of gears placed inside, outside or both sides of its body with no central axle, so that said magnetic rotor with said gears forms RIM Electric Motor/Generator and transmition mechanism at the same time.

2. Rim Motor/Generator (RMG) assembly comprising: said use of solenoid principle in specialized assembly of solenoids enclosed in rim (ring) shaped Stator with Core/Rotor spinning freely inside and a way of keeping the rotor in place through use of a series of gears as a means of support and transmission.

3. Although the invention has been described with specific applications in mind, it is known that there are many alternative applications, modifications, and variations on the applications described. Therefore, the invention as described and claimed, is to include such alternative applications, modifications, and variations that fall within the broad scope of the claims.
